(19) United States
(12) Patent Application Publication
(10) Pub. No.: US 2024/0258834 A1
(43) Pub. Date: Aug. 1, 2024

(54) CHARGER AND CHARGING METHOD

(71) Applicant: Panasonic Intellectual Property Management Co., Ltd., Osaka (JP)

(72) Inventors: Atsutoshi NARAKI, Kanagawa Ken (JP); Nobuyuki KITAMURA, Kanagawa Ken (JP); Hiromi HONGOU, Kanagawa Ken (JP); Yasuyuki KONDO, Kanagawa Ken (JP)

(73) Assignee: Panasonic Intellectual Property Management Co., Ltd., Osaka (JP)

(21) Appl. No.: 18/416,629

(22) Filed: Jan. 18, 2024

(30) Foreign Application Priority Data
Jan. 26, 2023 (JP) 2023-010096
Nov. 1, 2023 (JP) 2023-187375

(51) Int. Cl. H02J 50/20; H02J 7/00; H02J 50/80; H02J 50/90

(52) U.S. Cl. CPC H02J 50/20; H02J 7/00034; H02J 50/80; H02J 50/90

(57) ABSTRACT

A charger performs wireless charging on a terminal device that is placed on a tray (placement unit) and includes a power reception coil (power reception unit) configured to receive wirelessly transmitted power. The charger includes a memory and a processor coupled to the memory. The processor is configured to: instruct a power transmission coil (power transmission unit) to transmit power; detect a communication state between the power transmission coil and the power reception coil; acquire a charging frequency to be used for the wireless charging; detect movement of the terminal device; and change setting of the charging frequency when the movement of the terminal device is detected.

### CROSS-REFERENCE TO RELATED APPLICATIONS

This application is based upon and claims the benefit of priority from Japanese Patent Application No. 2023-010096, filed on Jan. 26, 2023 and Japanese Patent Application No. 2023-187375, filed on Nov. 1, 2023, the entire contents of which are incorporated herein by reference.

### FIELD

Embodiments described herein relate generally to a charger and a charging method.

### BACKGROUND

Recently, there is known a charger that performs contactless charging for a terminal device such as a smartphone (for example, Japanese Patent Application Laid-open No. 2014-124003). Such a charger allows a magnetic flux generated by an AC current flowing through a power transmission coil to pass through a power reception coil incorporated in a terminal device mounted on a charging stand, thereby generating an induced electromotive force by the effect of electromagnetic induction. The terminal device is charged by the induced electromotive force generated in the power reception coil.

An occurrence of interference between the charging frequency of the contactless charger and the receiving frequency of the AM radio of the vehicle may lead to occurrence of noise. For example, when the charging frequency of the contactless charger is 130 kHz, interference occurs when the receiving frequency of the AM radio is a multiple of 130 kHz. Equipping the charger with a function to acquire the receiving frequency of the AM radio would enable automatic switching of the charging frequency, but this leads to an increase in cost. Therefore, the charger disclosed in Japanese Patent Application Laid-open No. 2014-124003 switches the charging frequency by user's pressing on a button of the charger when noise occurs. However, repeatedly pressing the button while driving the vehicle is not preferable for safety reasons. This leads to a demand for a method of switching the charging frequency in a simpler manner.

### SUMMARY

A charger according to the present disclosure performs wireless charging on a terminal device that is placed on a placement unit and includes a power reception unit configured to receive wirelessly transmitted power. The charger includes a memory and a processor coupled to the memory. The processor is configured to: instruct a power transmission unit to transmit power; detect a communication state between the power transmission unit and the power reception unit; acquire a charging frequency to be used for the wireless charging; detect movement of the terminal device; and change setting of the charging frequency when the movement of the terminal device is detected.

### BRIEF DESCRIPTION OF THE DRAWINGS

FIG. 1 is a diagram illustrating an example of an external view of a charger according to an embodiment;

FIG. 2 is a block diagram illustrating an example of a schematic configuration of the charger according to the embodiment;

FIG. 3 is a diagram illustrating a moving state of a terminal device detected by the charger according to the embodiment;

FIG. 4 is a functional block diagram illustrating an example of a functional configuration of the charger according to the embodiment; and

FIG. 5 is a flowchart illustrating an example of a flow of processes performed by the charger of the embodiment.

### DETAILED DESCRIPTION

Hereinafter, an embodiment of a charger according to the present disclosure will be described with reference to the drawings.

### Schematic Configuration of Charger

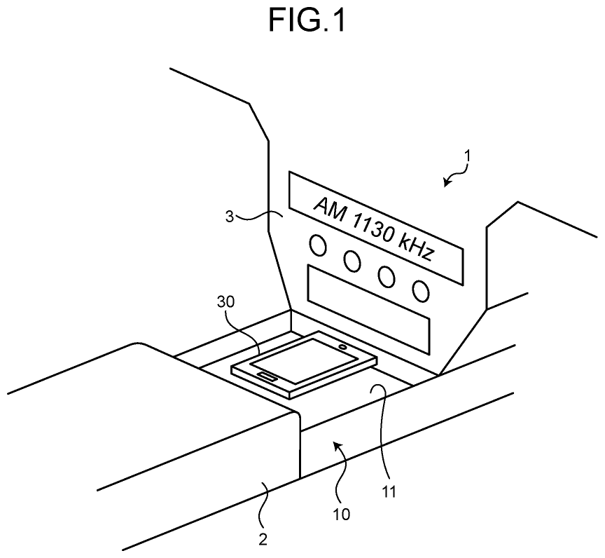

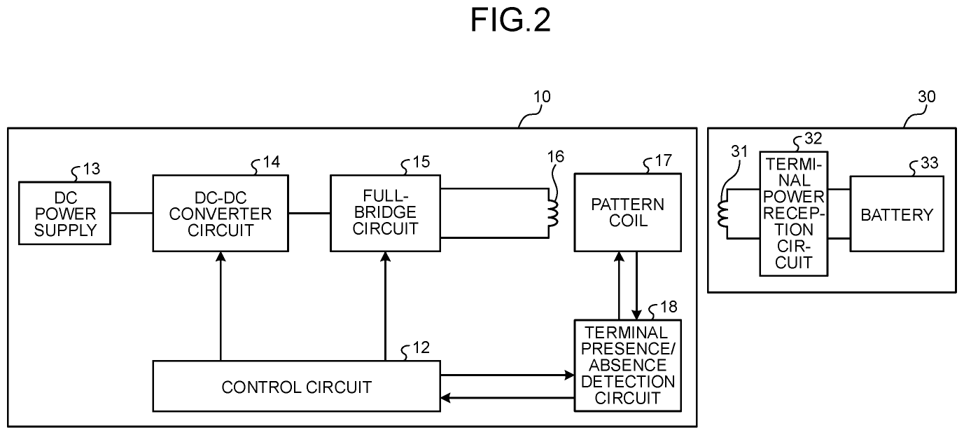

A schematic configuration of a charger 10 will be described with reference to FIGS. 1 and 2. FIG. 1 is a diagram illustrating an example of an external view of a charger according to an embodiment. FIG. 2 is a block diagram illustrating an example of a schematic configuration of the charger according to the embodiment.

As illustrated in FIG. 1, the charger 10 is installed on the front side of a center console 2 of a vehicle 1, that is, on a center cluster 3 side of the vehicle 1, for example, and performs wireless charging, that is, contactless charging of a terminal device 30 such as a smartphone placed on a tray 11. The tray 11 is an example of a placement unit in the present disclosure.

As illustrated in FIG. 2, the charger 10 includes a control circuit 12, a DC power supply 13, a DC-DC converter circuit 14, a full-bridge circuit 15, a power transmission coil 16, a pattern coil 17, and a terminal presence/absence detection circuit 18.

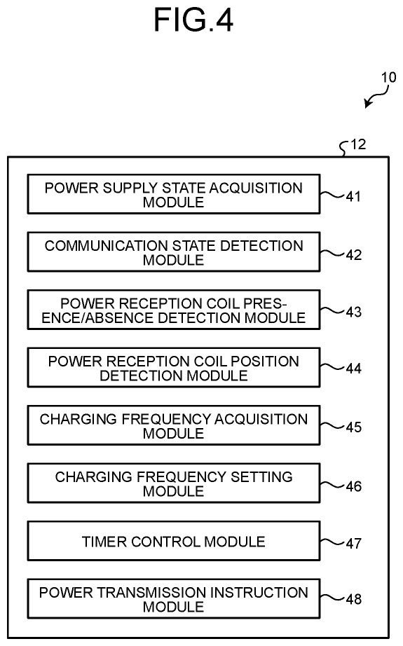

The control circuit 12 controls the overall operation of the charger 10. Various functions of the control circuit 12 will be described below in detail (refer to FIG. 4).

The DC power supply 13 supplies DC power used to activate the charger 10.

The DC-DC converter circuit 14 boosts the DC voltage of the DC power supply 13 to a predetermined DC voltage.

The full-bridge circuit 15 converts the DC voltage boosted by the DC-DC converter circuit 14 into an AC voltage.

The power transmission coil 16 generates an induced electromotive force in a power reception coil 31 included in the terminal device 30 by the principle of electromagnetic induction in accordance with the AC voltage applied from the full-bridge circuit 15. The power transmission coil 16 is an example of a power transmission unit in the present disclosure. In addition, in the present embodiment, the power transmission coil 16 is a movable coil capable of changing its position to a charging position with high charging efficiency in accordance with the position of the power reception coil 31 of the terminal device 30 that is in place. Note that the power transmission coil 16 may be provided in the form of a multi-coil including a plurality of fixed power transmission coils and configured to change the coil to be energized in accordance with the position of the power reception coil 31.

Having received the signal from the terminal presence/absence detection circuit 18, the pattern coil 17 transmits, to the terminal presence/absence detection circuit 18, a reflected wave that changes with the coupled state between the pattern coil 17 and the power reception coil 31.

The terminal presence/absence detection circuit 18 acquires the reflected wave from the pattern coil 17, and detects the position of the power reception coil 31. When not having been able to acquire the reflected wave from the pattern coil 17, the terminal presence/absence detection circuit 18 recognizes that there is no power reception coil 31, that is, the terminal device 30 has been removed from the tray 11.

The terminal device 30 includes a power reception coil 31, a terminal power reception circuit 32, and a battery 33.

The power reception coil 31 approaches the power transmission coil 16 to which the AC voltage is applied, thereby generating an induced electromotive force by the effect of electromagnetic induction. The power reception coil 31 is an example of a power reception unit in the present disclosure.

The terminal power reception circuit 32 generates a charging current according to the induced electromotive force generated in the power reception coil 31. The charging current generated by the terminal power reception circuit 32 charges the battery 33 of the terminal device 30.

The battery 33 is a secondary battery such as a lithium ion battery that supplies power to the terminal device 30.

### Moving State of Terminal Device Detected by Charger

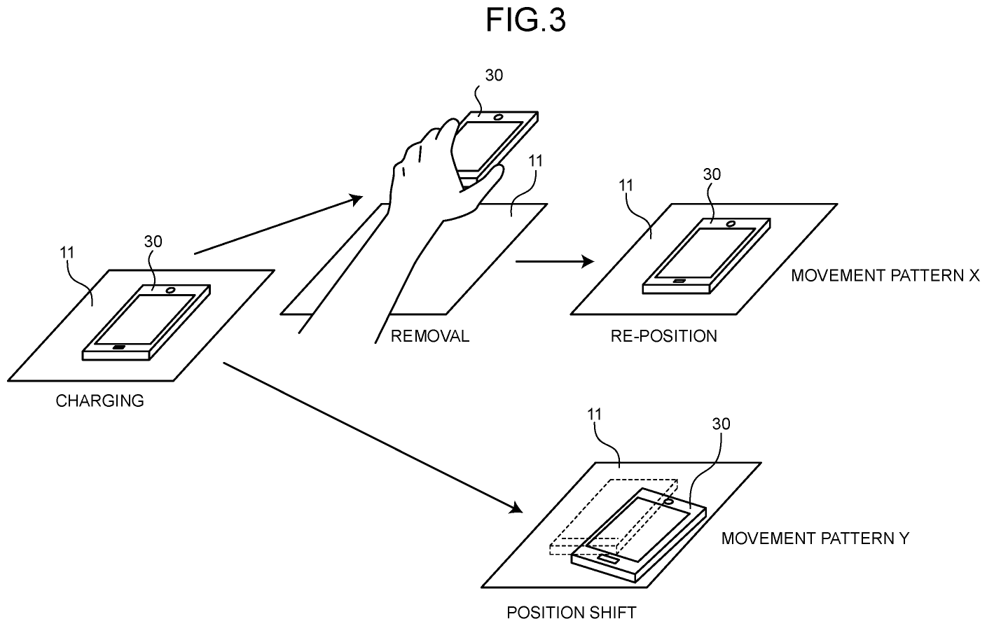

A moving state of the terminal device 30 detected by the charger 10 of the embodiment will be described with reference to FIG. 3. FIG. 3 is a diagram illustrating a moving state of a terminal device detected by the charger according to the embodiment.

The charger 10 changes the charging frequency when having detected one of two types of movement patterns of the terminal device 30 being charged.

A first pattern, that is a movement pattern X, is a movement pattern in which the currently charged terminal device 30 placed on the tray 11 is removed from the tray 11 and re-positioned on the tray 11.

The charger 10 detects disconnection of communication with the terminal device 30, and then detects the recovery of the communication within a predetermined time, thereby detecting occurrence of the movement pattern X. The movement pattern X is an example of a first movement pattern in the present disclosure.

A second pattern, that is, a movement pattern Y, is a movement pattern of shifting the placement position of the currently charged terminal device 30 placed on the tray 11 to another position in a state of being placed on the tray 11.

The charger 10 detects that the power reception coil 31 of the terminal device 30 has moved in the state of being placed on the tray 11 during charging, thereby detecting occurrence the movement pattern Y. For example, a power reception coil position detection module 44 (refer to FIG. 4) receives the reflected wave from the pattern coil 17, and detects occurrence the movement of the power reception coil 31 and the position of the power reception coil 31 after the movement based on the change in the magnitude of the received reflected wave. The movement pattern Y is an example of a second movement pattern in the present disclosure. In the case that the power transmission coil 16 is a multi-coil, it is possible to detect the shift of the position of the power reception coil 31 based on which coil of the power transmission coil 16 is used for power transmission to achieve reception of the largest power by the power reception coil 31.

### Functional Configuration of Charger

A functional configuration of the charger 10 will be described with reference to FIG. 4. FIG. 4 is a functional block diagram illustrating an example of a functional configuration of the charger according to the embodiment.

For example, the control circuit 12 of the charger 10 executes a control program stored in the control circuit 12 to implement a power supply state acquisition module 41, a communication state detection module 42, a power reception coil presence/absence detection module 43, a power reception coil position detection module 44, a charging frequency acquisition module 45, a charging frequency setting module 46, a timer control module 47, and a power transmission instruction module 48 illustrated in FIG. 4, as functional parts. Some or all of these functional parts may be implemented by hardware.

The power supply state acquisition module 41 acquires a state of an accessory power supply (ACC power supply), for example, as a power supply that supplies power to the charger 10.

The communication state detection module 42 detects a communication state between the power transmission coil 16 (power transmission unit) and the power reception coil 31 (power reception unit).

The power reception coil presence/absence detection module 43 detects whether the terminal device 30 is placed on the tray 11. The power reception coil presence/absence detection module 43 is an example of a movement detection module in the present disclosure.

The power reception coil position detection module 44 receives the reflected wave from the pattern coil 17, and detects the occurrence the movement of the power reception coil 31 and the position of the power reception coil 31 on the tray 11 based on the change in the magnitude of the received reflected wave. The power reception coil position detection module 44 is an example of a movement detection module in the present disclosure.

The charging frequency acquisition module 45 acquires a charging frequency used for wireless charging.

The charging frequency setting module 46 changes the setting of the charging frequency when the power reception coil presence/absence detection module 43 and the power reception coil position detection module 44 have detected the movement of the terminal device 30. The charging frequency setting module 46 instructs the full-bridge circuit 15 to change the charging frequency.

The timer control module 47 performs reset control and count-up control of timers (timer A and timer B to be described below) to be activated when the power reception coil presence/absence detection module 43 and the power reception coil position detection module 44 detect the movement of the terminal device 30.

The power transmission instruction module 48 instructs the power transmission coil 16 (power transmission unit) to transmit power, that is, to perform charging.

### Flow of Processes Performed by Charger

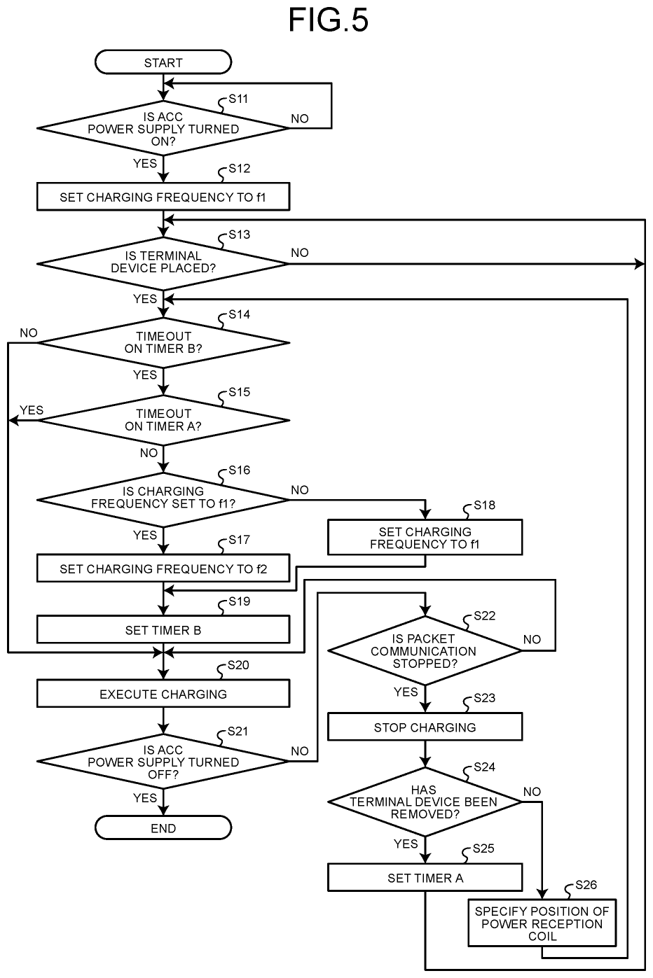

A flow of processes performed by the charger 10 will be described with reference to FIG. 5. FIG. 5 is a flowchart illustrating an example of a flow of processes performed by the charger of the embodiment.

Before describing the flowchart of FIG. 5, two types of timers included in the charger 10 will be described. The charger 10 includes two types of timers, a timer A and a timer B.

The timer A is a timer that measures a time from the removal of the terminal device 30 from the tray 11 to the re-positioning of the terminal device 30 on the tray 11. The timer A is set to three seconds, for example. That is, when the terminal device 30 is re-positioned on the tray 11 within three seconds after being removed from the tray 11, the charger 10 of the present embodiment determines that the movement pattern X described with reference to FIG. 3 has occurred. Note that the time set in the timer A, that is, the above-described three seconds is a first predetermined time in the present disclosure. In contrast, in a case where the terminal device 30 is re-positioned on the tray 11 after passage of more than three seconds from the removal of the terminal device 30 from the tray 11, the charger 10 of the present embodiment does not determine that the movement pattern X has occurred.

In addition, the charger 10 interrupts the detection of the movement of the terminal device 30, for example, for six seconds after detecting the occurrence of the movement pattern X or the movement pattern Y. The timer B is a timer that measures an elapsed time from the occurrence of the movement pattern X or the movement pattern Y. In this manner, the reason why the detection of the movement of the terminal device 30 is interrupted for a predetermined time after detection of the occurrence of the movement pattern X or the movement pattern Y is to prevent the charging frequency from being changed each time the user accidentally moves the terminal device 30. Note that the time set in the timer B is a second predetermined time in the present disclosure.

Hereinafter, an example of a flow of processes performed by the charger 10 will be described with reference to FIG. 5.

The power supply state acquisition module 41 determines whether an accessory power supply (ACC power supply) of the vehicle 1, as a device that supplies power to the charger 10, is turned on (Step S11). When it is determined that the accessory power supply of the vehicle 1 is turned on (Step S11: Yes), the process proceeds to Step S12. In contrast, when it is not determined that the accessory power supply of the vehicle 1 is turned on (Step S11: No), Step S11 is repeated.

When it is determined in Step S11 that the accessory power supply of the vehicle 1 is turned on, the charging frequency setting module 46 sets the charging frequency of the terminal device 30 to a predetermined charging frequency f1 (Step S12).

The power reception coil presence/absence detection module 43 determines whether the terminal device 30 is placed on the tray 11 (Step S13). When it is determined that the terminal device 30 is placed on the tray 11 (Step S13: Yes), the process proceeds to Step S14. In contrast, when it is not determined that the terminal device 30 is placed on the tray 11 (Step S13: No), Step S13 is repeated.

When it is determined in Step S13 that the terminal device 30 is placed on the tray 11, the timer control module 47 determines whether the timer B is in a timeout state (Step S14). When it is determined that timer B is in a timeout state (Step S14: Yes), the process proceeds to Step S15. In contrast, when it is not determined that the timer B is in the timeout state (Step S14: No), the process proceeds to Step S20. Note that the timer B being in the timeout state indicates that a predetermined time has elapsed from the start of count-up on the timer B.

When it is determined in Step S14 that the timer B is in a timeout state, the timer control module 47 determines whether the timer A is in a timeout state (Step S15). When it is determined that the timer A is in a timeout state (Step S15: Yes), the process proceeds to Step S20. In contrast, when it is not determined that the timer A is in the timeout state (Step S15: No), the process proceeds to Step S16. Note that the timer A being in the timeout state indicates that a predetermined time has elapsed from the start of count-up on the timer A.

When not determined in Step S15 that the timer A is in the timeout state, the charging frequency setting module 46 determines whether the charging frequency is set to the charging frequency f1 (Step S16). When it is determined that the charging frequency is set to the charging frequency f1 (Step S16: Yes), the process proceeds to Step S17. In contrast, when it is not determined that charging frequency is set to the charging frequency f1 (Step S16: No), the process proceeds to Step S18.

When it is determined in Step S16 that the charging frequency is set to the charging frequency f1, the charging frequency setting module 46 sets the charging frequency of the terminal device 30 to a predetermined charging frequency f2 (Step S17). Thereafter, the process proceeds to Step S19.

In contrast, when it is not determined in Step S16 that the charging frequency is set to the charging frequency f1, the charging frequency setting module 46 sets the charging frequency of the terminal device 30 to the predetermined charging frequency f1 (Step S18). Thereafter, the process proceeds to Step S19.

Following Step S17 or Step S18, the timer control module 47 sets the timer B (Step S19). Note that setting the timer B means resetting the timer B to start count-up.

Subsequent to Step S19, or when it is determined in Step S14 that timer B is not in a timeout state, or when it is determined in Step S15 that timer A is in a timeout state, the power transmission instruction module 48 performs charging to the terminal device 30 (Step S20).

The power supply state acquisition module 41 determines whether an accessory power supply (ACC power supply) of the vehicle 1, as a device that supplies power to the charger 10, is turned off (Step S21). When it is determined that the accessory power supply of the vehicle 1 is turned off (Step S21: Yes), the charger 10 ends the process of FIG. 5. In contrast, when it is not determined that the accessory power supply of the vehicle 1 is turned off (Step S21: No), the process proceeds to Step S22.

When it is not determined in Step S21 that the accessory power supply of the vehicle 1 is turned off, the communication state detection module 42 determines whether the packet communication between the power transmission coil 16 and the power reception coil 31 is stopped (Step S22). When it is determined that the packet communication between the power transmission coil 16 and the power reception coil 31 is stopped (Step S22: Yes), the process proceeds to Step S23. In contrast, when it is not determined that the packet communication between the power transmission coil 16 and the power reception coil 31 is stopped (Step S22: No), the process returns to Step S20.

When it is determined in Step S22 that the packet communication between the power transmission coil 16 and the power reception coil 31 is stopped, the power transmission instruction module 48 stops the charging to the terminal device 30 (Step S23).

The power reception coil presence/absence detection module 43 determines whether the terminal device 30 has been removed from the tray 11 (Step S24). When it is determined that the terminal device 30 has been removed from the tray 11 (Step S24: Yes), the process proceeds to Step S25. In contrast, when it is not determined that the terminal device 30 has been removed from the tray 11 (Step S24: No), the process proceeds to Step S26.

When it is determined in Step S24 that the terminal device 30 has been removed from the tray 11, the timer control module 47 sets the timer A (Step S25). Note that setting the timer A means resetting the timer A to start count-up. Thereafter, the process returns to Step S13.

In contrast, when it is not determined in Step S24 that the terminal device 30 has been removed from the tray 11, the power reception coil position detection module 44 specifies the position of the power reception coil 31 after the movement, on the tray 11 (Step S26). Thereafter, the process returns to Step S14.

Although not illustrated in FIG. 5, the charger 10 may operate as follows. For example, in the flowchart of FIG. 5, the charger 10 alternately switches the two types of charging frequencies f1 and f2, but the charger 10 may 10 may alternately switch three or more types of charging frequencies.

Furthermore, when the power reception coil presence/absence detection module 43 or the power reception coil position detection module 44 (movement detection module) has detected the movement of the terminal device 30, the charging frequency setting module 46 may shift the charging frequency set at that time by a predetermined frequency in an increasing direction or a decreasing direction.

Moreover, the charging frequency setting module 46 may change the charging frequency only when the power reception coil position detection module 44 detects a predetermined movement pattern Y. Regarding the predetermined movement pattern Y, for example, the charging frequency setting module 46 may change the charging frequency only when the power reception coil position detection module 44 has detected the movement of the terminal device 30 to the right end of the tray 11. Alternatively, the charging frequency setting module 46 may change the charging frequency only when the power reception coil position detection module 44 has detected a complex motion such as moving the terminal device 30 by a predetermined amount in the front-rear direction after moving the terminal device 30 by a predetermined amount in the left-right direction with respect to the traveling direction of the vehicle 1. In this manner, by detecting only a specific movement pattern, for example, it is possible to prevent the charging frequency from being changed by the movement of the terminal device 30 due to the vibration of the vehicle 1.

Furthermore, the charging frequency setting module 46 may change the charging frequency when the power reception coil presence/absence detection module 43 and the power reception coil position detection module 44 have detected the occurrence movement pattern X or movement pattern Y twice in a row during the predetermined time. Specifically, the timer control module 47 activates a timer C when the movement pattern X or the movement pattern Y has occurred. The timer C is set to ten seconds, for example. The charging frequency setting module 46 changes the charging frequency in a case where the movement pattern X or the movement pattern Y occurred again while the timer C is operating, that is, within ten seconds after occurrence the movement pattern X or the movement pattern. In this manner, the reason why the charging frequency is changed in a case where the same movement pattern is detected twice in a row is to prevent the charging frequency from being changed each time when the user accidentally moves the terminal device 30. Note that the time set in the timer C is a third predetermined time in the present disclosure.

In addition, the charger 10 need not include the terminal presence/absence detection circuit 18. In this case, the charger 10 may determine that the terminal device 30 has been removed from the tray 11 when there is no response from the full-bridge circuit 15.

In addition, the charger 10 may set the charging frequency to be changed in accordance with the time until the terminal device 30 removed from the tray 11 is re-positioned. For example, the frequency may be changed to the charging frequency f1 in a case where the time until re-positioning is within three seconds, and may be changed to the charging frequency f2 in a case where the time until re-positioning is within a period of three seconds or more and six seconds or less.

Although not illustrated in FIG. 5, the power reception coil presence/absence detection module 43 and the power reception coil position detection module 44 may acquire, from the terminal device 30, information uniquely specifying the terminal device 30 when communication is performed between the power transmission coil 16 and the power reception coil 31. Thereafter, when it is determined that a different terminal device 30 is placed due to the movement of the terminal device 30, the charging frequency setting module 46 may set the charging frequency to the predetermined charging frequency f1.

### Action and Effect of Present Embodiment

As described above, the charger 10 according to the present embodiment is a charger that performs wireless charging to the terminal device 30 that is placed on the tray 11 (placement unit) and that includes the power reception coil 31 (power reception unit) that receives the wirelessly transmitted power. The charger 10 includes: the power transmission instruction module 48 that instructs the power transmission coil 16 (power transmission unit) to transmit power; the communication state detection module 42 that detects the communication state between the power transmission coil 16 and the power reception coil 31; the charging frequency acquisition module 45 that acquires the charging frequency used for the wireless charging; the power reception coil presence/absence detection module 43 and the power reception coil position detection module 44 (movement detection module) that detect the movement of the terminal device 30; and the charging frequency setting module 46 that changes the setting of the charging frequency when the power reception coil presence/absence detection module 43 and the power reception coil position detection module 44 have detected the movement of the terminal device 30. Therefore, even when the charger 10 cannot acquire the receiving frequency of the AM radio, the charging frequency of the charger 10 can be switched in a simple manner.

In the charger 10 according to the present embodiment, the power reception coil presence/absence detection module 43 and the power reception coil position detection module 44 (movement detection module) detect the movement pattern X (first movement pattern) in which the terminal device 30 removed from the tray 11 (placement unit) is re-positioned within the first predetermined time, and the movement pattern Y (second movement pattern) in which the placement position of the terminal device 30 is changed while the terminal device 30 is placed on the tray 11. This makes it possible to reliably and easily detect the movement pattern of the terminal device 30.

Furthermore, in the charger 10 according to the present embodiment, when having detected the occurrence of the movement pattern X (first movement pattern) or the movement pattern Y (second movement pattern) of the terminal device 30, the power reception coil presence/absence detection module 43 and the power reception coil position detection module 44 (movement detection module) suppress detection of the occurrence of the movement of the terminal device 30 for the second predetermined time from the time of detection of the movement. Therefore, it is possible, for example, to reliably identify the movement of the terminal device 30 due to the vibration of the vehicle 1 and the movement of the terminal device 30 intended by the user for switching the charging frequency.

In the charger 10 according to the present embodiment, the charging frequency setting module 46 changes the plurality of predetermined charging frequencies in a predetermined order every time the power reception coil presence/absence detection module 43 or the power reception coil position detection module 44 (movement detection module) has detected the movement of the terminal device 30. Therefore, the charging frequency can be easily changed.

Furthermore, in the charger 10 according to the present embodiment, when the power reception coil presence/absence detection module 43 or the power reception coil position detection module 44 (movement detection module) has detected the movement of the terminal device 30, the charging frequency setting module 46 shifts the charging frequency set at the time of detection by a predetermined frequency. Therefore, the charging frequency can be easily changed.

Furthermore, in the charger 10 according to the present embodiment, the charging frequency setting module 46 changes the setting of the charging frequency when the power reception coil presence/absence detection module 43 and the power reception coil position detection module 44 (movement detection module) have detected the movement of the terminal device 30 multiple times during the third predetermined time. This makes it possible to prevent the charging frequency from being changed each time when the user accidentally moves the terminal device 30.

According to the charger of the present disclosure, the charging frequency of the charger can be switched by a simple method.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charger that performs wireless charging on a terminal device, the terminal device being placed on a placement unit and including a power reception unit configured to receive wirelessly transmitted power, the charger comprising:
a memory; and
a processor coupled to the memory and configured to:
instruct a power transmission unit to transmit power;
detect a communication state between the power transmission unit and the power reception unit;
acquire a charging frequency to be used for the wireless charging;
detect movement of the terminal device; and
change setting of the charging frequency when the movement of the terminal device is detected.

2. The charger according to claim 1, wherein
the processor is configured to detect a first movement pattern in which the terminal device removed from the placement unit is re-positioned within a first predetermined time, and a second movement pattern in which a placement position of the terminal device is changed while the terminal device is placed on the placement unit.

3. The charger according to claim 2, wherein
the processor is configured not to detect, when occurrence of the first movement pattern or the second movement pattern of the terminal device is detected, occurrence of the movement of the terminal device during a second predetermined time from a time of detection of the movement.

4. The charger according to claim 1, wherein
the processor is configured to change a plurality of predetermined charging frequencies in a predetermined order each time the movement of the terminal device is detected.

5. The charger according to claim 2, wherein
the processor is configured to change a plurality of predetermined charging frequencies in a predetermined order each time the movement of the terminal device is detected.

6. The charger according to claim 1, wherein
the processor is configured to shift, when the movement of the terminal device is detected, a charging frequency set at a time of detection by a predetermined frequency.

7. The charger according to claim 2, wherein
the processor is configured to shift, when the movement of the terminal device is detected, a charging frequency set at a time of detection by a predetermined frequency.

8. The charger according to claim 1, wherein
the processor is configured to change the setting of the charging frequency when the movement of the terminal device is detected multiple times during a third predetermined time.

9. The charger according to claim 2, wherein
the processor is configured to change the setting of the charging frequency when the movement of the terminal device is detected multiple times during a third predetermined time.

10. A charging method of performing wireless charging on a terminal device, the terminal device being placed on a placement unit and including a power reception unit configured to receive wirelessly transmitted power, the method comprising:
instructing a power transmission unit to transmit power;
detecting a communication state between the power transmission unit and the power reception unit;
acquiring a charging frequency to be used for the wireless charging;
detecting movement of the terminal device; and
changing setting of the charging frequency when the movement of the terminal device is detected.

11. The charging method according to claim 10, wherein
the detecting the movement of the terminal device includes detecting a first movement pattern in which the terminal device removed from the placement unit is re-positioned within a first predetermined time, and a second movement pattern in which a placement position of the terminal device is changed while the terminal device is placed on the placement unit.

12. The charging method according to claim 11, wherein
the detecting the movement of the terminal device includes not detecting, when occurrence of the first movement pattern or the second movement pattern of the terminal device is detected, occurrence of the movement of the terminal device during a second predetermined time from a time of detection of the movement.

13. The charging method according to claim 10, wherein
the changing the setting of the charging frequency includes changing a plurality of predetermined charging frequencies in a predetermined order each time the movement of the terminal device is detected.

14. The charging method according to claim 11, wherein
the changing the setting of the charging frequency includes changing a plurality of predetermined charging frequencies in a predetermined order each time the movement of the terminal device is detected.

15. The charging method according to claim 10, wherein
the changing the setting of the charging frequency includes shifting, when the movement of the terminal device is detected, a charging frequency set at a time of detection by a predetermined frequency.

16. The charging method according to claim 11, wherein
the changing the setting of the charging frequency includes shifting, when the movement of the terminal device is detected, a charging frequency set at a time of detection by a predetermined frequency.

17. The charging method according to claim 10, wherein
the changing the setting of the charging frequency includes changing the setting of the charging frequency when the movement of the terminal device is detected multiple times during a third predetermined time.

18. The charging method according to claim 11, wherein
the changing the setting of the charging frequency includes changing the setting of the charging frequency when the movement of the terminal device is detected multiple times during a third predetermined time.
